(19) United States
(12) Patent Application Publication
(10) Pub. No.: US 2016/0377788 A1
(43) Pub. Date: Dec. 29, 2016

(54) BACKLIGHT MODULE AND LIQUID CRYSTAL DISPLAY DEVICE USING THE SAME

(71) Applicant: SHENZHEN CHINA STAR OPTOELECTRONICS TECHNOLOGY CO., LTD., Shenzhen,Guangdong (CN)

(72) Inventor: Chengwen QUE, Shenzhen, Guangdong (CN)

(73) Assignee: Shenzhen China Star Optpelectronics Technology Co., Ltd., Shenzhen,Guangdong (CN)

(21) Appl. No.: 14/888,157

(22) PCT Filed: May 19, 2015
(86) PCT No.: PCT/CN2015/079246

§ 371 Date: Oct. 30, 2015

(30) Foreign Application Priority Data
Mar. 2, 2015 (CN) 201510092210.2

(51) Int. Cl. F21V 8/00

(52) U.S. Cl. CPC G02B 6/0016; G02B 6/0021; G02B 6/0031; G02B 6/0026; G02B 6/0068

(57) ABSTRACT

A backlight module includes a light guiding plate with a light incident lateral surface. Pluralities of V-shaped grooves are disposed on the light incident lateral surface, the grooves are disposed along the light incident lateral surface in a direction of width of the light guiding plate with equal interval, and light emitting modules are disposed respectively on the opposite position of the slopes of the grooves correspondingly. The present invention further provides a liquid crystal display device equipped with the backlight module. The backlight module and the liquid crystal display device equipped with the backlight module can improve the brightness of the backlight module efficiently.

### BACKGROUND

1. Technical Field

The present invention relates to the technical field of liquid crystal display, and particularly to a backlight module that can improve the brightness and a liquid crystal display device equipped with the backlight module.

2. Description of the Related Art

Among the current technologies of liquid crystal display devices, a white light emitting diode (LED) is prevalently used as backlight. Light guiding plates collaborating with optical films provide the backlight for the liquid crystal display devices. As increasing demand for high color gamut, color saturation and energy conservation, methods of producing white light, high color gamut and color saturation includes: using ultraviolet LED cooperating with RGB fluorescent powders; using blue LED cooperationg with red and green fluorescent powders; combining blue LED, green LED and red LED, etc. The methods above can enlarge color gamut. However, the operation is difficult as well as pricy.

A quantum dot (QD) is a nanocrystal made of semiconductor that can confine electrons within certain limits, it consists of micro crystal compounds in the size of 1-100 nm. In the realm of the quantum dot, the wavelengths of the light can be adjustable by controlling the sizes of the crystal to achieve the exact color of light. Therefore, quantum dot materials are employed in the backlight modules, replacing the conventional white LED with high frequency spectrum lights such as blue LED. Irradiated by high frequency light, the quantum dot materials can be excited to generate light of various wavelengths. With different sizes, the quantum dot can emit light of different colors to meet the request of the backlight of the liquid crystal display devices with high color gamut.

FIG. 1 is a conventional backlight module equipped with a quantum dot glass tube. Referring to FIG. 1, a blue LED 11 is disposed directly on an opposite position of a light incident lateral surface 121 of a light guiding plate 12. Quantum dots packaged in a glass tube form a quantum dot glass tube 13. The quantum dot glass tube 13 is disposed between the blue LED 11 and the light incident lateral surface 121 of the light guiding plate 12. Blue light emitted from the blue LED 11 runs through the quantum dot glass tube 13 and strikes on the light incident lateral surface 121 of the light guiding plate 12. However, much of the energy of the light from the blue LED 11 has been consumed during passing through the quantum dot glass tube 13, which causes brightness reduction of the backlight module of FIG. 1.

### BRIEF SUMMARY

To solve the problems discussed above, the present invention aims to provide a backlight module including a light guiding plate with a light incident lateral surface. A number of V-shaped grooves are disposed on the light incident lateral surface. Light-emitting module are disposed respectively on the opposite position of slope of each V-shaped groove.

In an embodiment of the present invention, the V-shaped grooves are disposed along the light incident lateral surface in a direction of width of the light guiding plate with equal interval.

In an embodiment of the present invention, each V-shaped groove is symmetrical.

In an embodiment of the present invention, each V-shaped groove has two slopes, and the two light emitting modules are disposed respectively on the opposite position of the two slopes.

In an embodiment of the present invention, each V-shaped groove is asymmetrical.

In an embodiment of the present invention, the pluralities of V-shaped grooves are symmetrical related to a central normal of the light incident lateral surface.

In an embodiment of the present invention, each V-shaped groove contains a long slope and a short slope, and the light emitting modules are disposed respectively on the opposite position of the long slopes of the V-shaped grooves respectively.

In an embodiment of the present invention, each short slope of the V-shaped groove is coated with a reflecting layer.

In an embodiment of the present invention, each of the light emitting modules includes a circuit board, at least one light emitting diode disposed on the circuit board and a quantum dot glass tube disposed opposite to the circuit board. The circuit board is disposed opposite to the slope of the V-shaped groove. The quantum dot glass tube is disposed between the circuit board and the slope of the V-shaped groove. The quantum dot glass tube switches light from the light emitting diode to white light.

The present invention further provides a liquid crystal display device equipped with the backlight module mentioned above.

The present invention provides the backlight module and the liquid crystal display device equipped with the backlight module that can improve the brightness of the backlight module efficiently.

### BRIEF DESCRIPTION OF THE DRAWINGS

These and other features and advantages of the various embodiments disclosed herein will be better understood with respect to the following description and drawings, and in which:

FIG. 1 is a conventional backlight module equipped with a quantum dot glass tube.

FIG. 2 is a schematic view of a LCD device of the present invention.

FIG. 3 is a partial top plan, schematic view of a backlight module according to a first exemplary embodiment of the present invention.

FIG. 4 is a partial top plan, schematic view of a backlight module according to a second exemplary embodiment of the present invention.

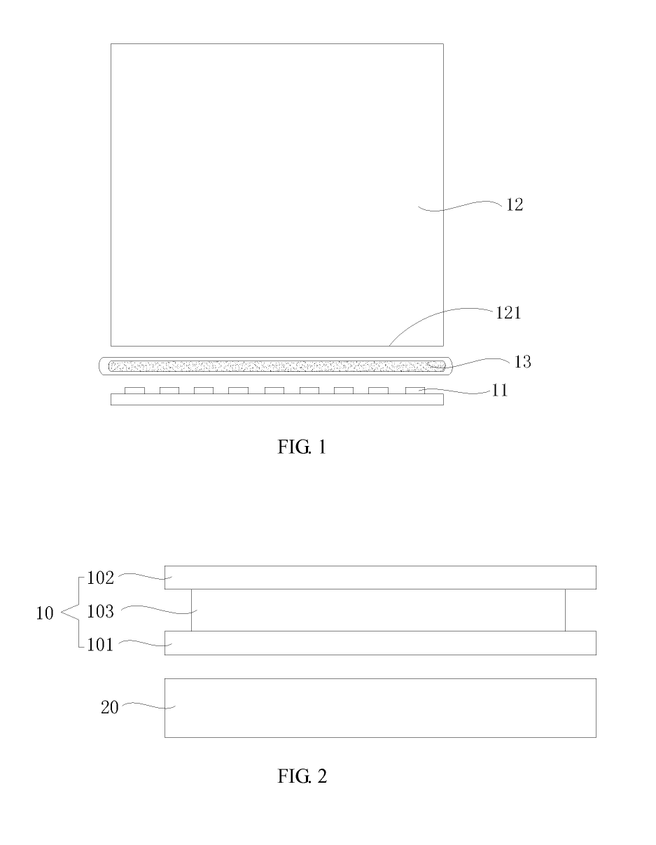

### DETAILED DESCRIPTION

The following illustration referring to the drawings explains the details of each exemplary embodiment of the present invention. However, more than one way could implement the present invention. As such, it is to be clarified that the exemplary embodiments are used for purposes of illustration that could help other technical staff understand the principle as well as various modifications due to specific targets, rather than being regarded as limits.

FIG. 2 is a schematic view of a LCD device of the present invention.

Referring to FIG. 2, the LCD device includes a liquid crystal display panel 10 and a backlight module 20 disposed opposite to the LCD panel 10. The backlight module 20 provides optical source to LCD panel 10 for displaying image.

In general, the LCD panel 10 can include a thin film transistor (TFT) array substrate 101, a color filter (CF) substrate 102 disposed opposite to the thin film transistor array substrate 101 and a liquid crystal layer 103 disposed between the thin film transistor array substrate 101 and the color filter substrate 102. The liquid crystal layer 103 can include a number of liquid crystal molecules. As the structure of the LCD panel 10 can be similar to that of conventional LCD panels, more details are omitted here.

The following section will describe the structure of backlight module 20 in details.

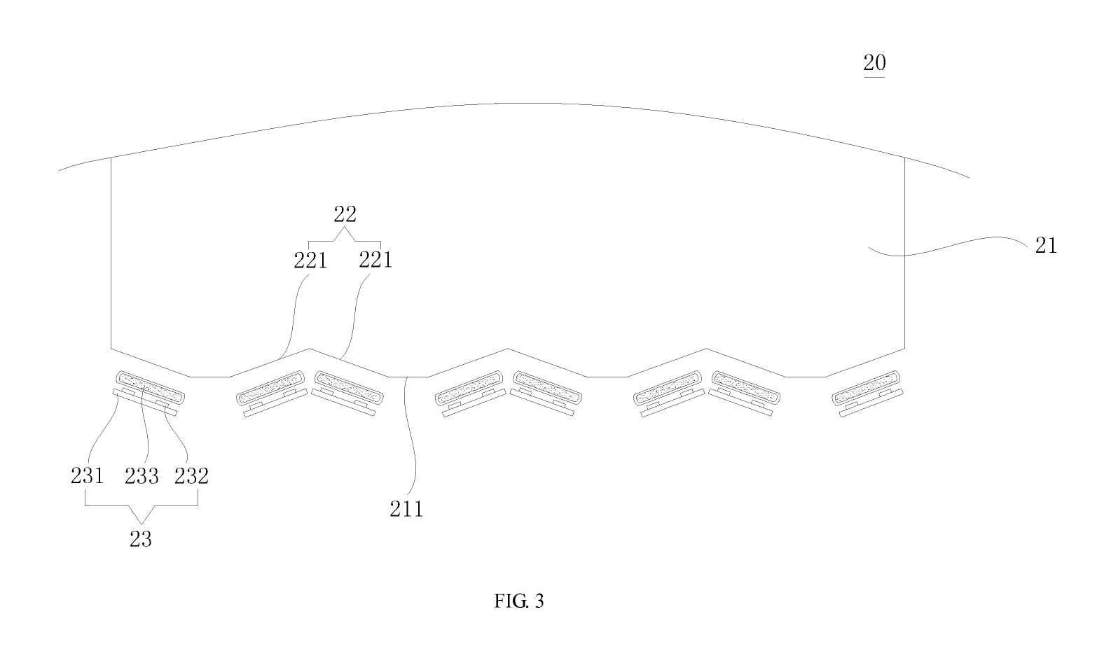

FIG. 3 is a partial top plan, schematic view of the backlight module according to the first exemplary embodiment of the present invention.

Referring to FIG. 3, a backlight module 20 according to the first exemplary embodiment of the present invention can include a light guiding plate 21. The light guiding plate 21 has a light incident lateral surface 211. A number of V-shaped grooves 22 are disposed on the light incident lateral surface 211. The light emitting modules 23 are disposed respectively on the opposite position of the slopes of the grooves 22.

In an embodiment of the present invention, the grooves 22 are disposed along the light incident lateral surface 211 in a direction of width of the light guiding plate 21 with equal interval. It is to be understood that the invention is not limited herein.

In this invention, preferably, the V-shaped grooves 22 are symmetrical structure, in other words, one of the two slopes 211 of the V-shaped grooves 22 is an exact mirror image of the other.

Furthermore, in an embodiment of the present invention, the light-emitting modules 23 are disposed respectively on the opposite position of the each of two slopes 221 of the V-shaped grooves 22. In this way, in order to increase the number of the light emiting modules 23, numerous V-shaped grooves 22 are disposed on the light incident lateral surface 211 and the light-emitting modules 23 are disposed respectively on the opposite position of the each of the two slopes 221 of the V-shaped grooves 22, so as to improve the brightness of the backlight module according to the first exemplary embodiment of the present invention.

Moreover, according to the first exemplary embodiment of the present invention, the light emitting module 23 includes a circuit board 231, two LEDs 232 such as blue LED disposed on the circuit board 231 and a quantum dot glass tube 233 disposed opposite to the circuit board 231, and the circuit board 231 locates opposite to the slope 221 of the corresponding V-shaped groove 22. The quantum dot glass tube 233 can be disposed between the circuit board 231 and the slope 221 of the V-shaped groove 22, the quantum dot glass tube 233 switches light from the light emitting diode 232 to white light. To be clear, the quantity of LED 232 is not limited as shown in FIG. 3.

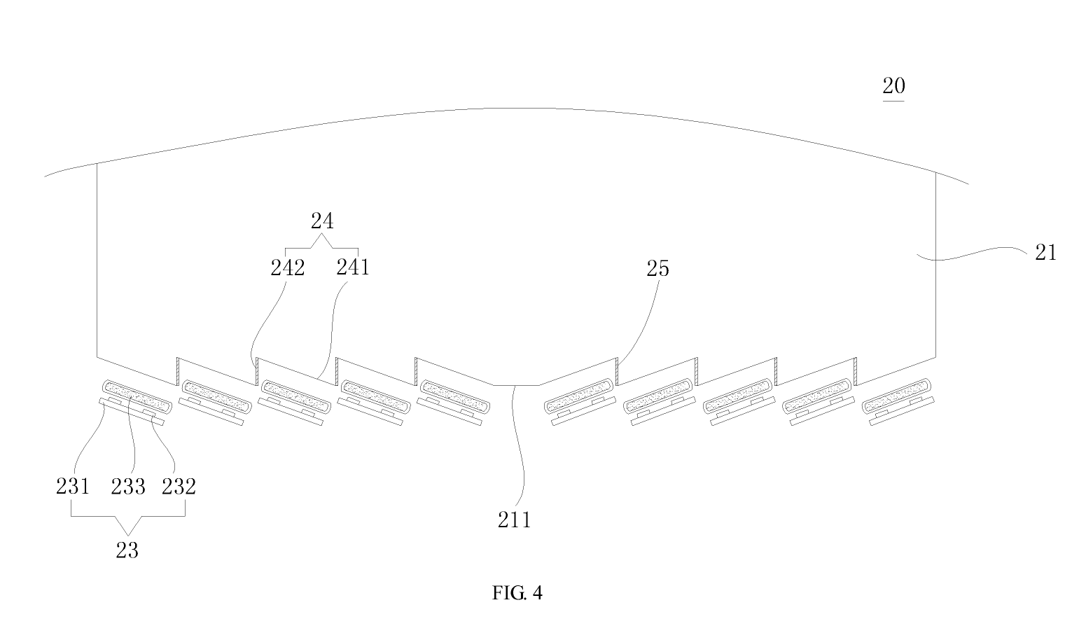

FIG. 4 is a partial top plan, schematic view of the backlight module according to the second exemplary embodiment of the present invention.

Referring to FIG. 4, according to the second exemplary embodiment of the present invention, the backlight module includes the light guiding plate 21 with the light incident lateral surface 211. The light incident lateral surface 211 can be equipped with a number of V-shaped grooves 24, and the light emitting module 23 are disposed respectively on opposite position to each of the long slopes of the V-shaped grooves 24.

In this embodiment, the V-shaped grooves 24 are asymmetrical. Moreover, the amounts of V-shaped grooves 24 are symmetrical related to a central normal of the light incident lateral surface 211.

Furthermore, the light emitting modules 23 are respectively disposed on the opposite position of a long slope 241 of each groove 24. In this way, in order to increase the number of the light emitting modules 23, numerous V-shaped grooves 24 are disposed on the light incident lateral surface 211. The light emitting modules 23 are respectively disposed on the opposite position of the long slope 241 of each groove 24, so as to improve the brightness of the backlight module according to the second exemplary embodiment of the present invention. Moreover, a reflectioning layer 25 is mounted on a short slope 242 of each groove 24. The reflecting layer 25 reflects the light incidenting to the short slope 242 back to the light guiding plate 21 in order to increase the utilization rate of light.

In addition, according to the second exemplary embodiment of the present invention, the light-emitting module 23 includes the circuit board 231, two LEDs 232 such as blue LEDs disposed on the circuit board 231 and the quantum dot glass tube 233 disposed opposite to the circuit board 231. The circuit board 231 locates opposite to the slope 221 of the corresponding V-shaped groove 24, the quantum dot glass tube 233 is disposed between the circuit board 231 and the slope 221 of the V-shaped groove 24. The quantum dot glass tube 233 switches light from the light emitting diode 232 to white light. To be clear, the quantity of LED 232 is not limited as shown in FIG. 4.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated.

What is claimed is:

1. A backlight module comprising:
a light guiding plate with a light incident lateral surface, wherein a plurality of V-shaped grooves are disposed on the light incident lateral surface, the grooves are disposed along the light incident lateral surfaces in a direction of width of the light guiding plate with equal interval, and light emitting modules are disposed respectively on the opposite position of the slopes of the V-shaped grooves.

2. The backlight module according to claim 1, wherein each V-shaped groove is symmetrical.

3. The backlight module according to claim 2, wherein each V-shaped groove has two slopes, the two light emitting modules are disposed respectively on the opposite position of the two slopes of the V-shaped grooves.

4. The backlight module according to claim 1, wherein each V-shaped groove is asymmetrical.

5. The backlight module according to claim 4, wherein the pluralities of V-shaped grooves are symmetrical related to a central normal of the light incident lateral surface.

6. The backlight module according to claim 4, wherein each V-shaped groove contains a long slope and a short slope, the light emitting modules are disposed on the opposite position of the long slopes of each of the V-shaped grooves respectively.

7. The backlight module according to claim 4, wherein reflecting layers are disposed on the short slopes of the V-shaped grooves.

8. The backlight module according to claim 1, wherein each of the light emitting modules comprises a circuit board, at least one light emitting diode disposed on the circuit board and a quantum dot glass tube disposed opposite to the circuit board, the circuit board is disposed opposite to the slope of the V-shaped groove, the quantum dot glass tube is disposed between the circuit board and the slope of the V-shaped groove, the quantum dot glass tube switches the light from the emitting diode to white light.

9. A liquid crystal display device comprising:
a liquid crystal display panel and a backlight module opposite to the LCD panel, wherein the backlight module comprises a light guiding plate with a light incident lateral surface, a plurality of V-shaped grooves disposed on the light incident lateral surface, the grooves are disposed along the light incident lateral surface in a direction of width of the light guiding plate with equal interval, and light emitting modules are disposed respectively on the opposite position of the slopes of the V-shaped grooves correspondingly.

10. The liquid crystal display device according to claim 9, wherein each V-shaped groove is symmetrical.

11. The liquid crystal display device according to claim 10, wherein each V-shaped groove has two slopes, the two light emitting modules are disposed respectively on the opposite position of the two slopes of the V-shaped grooves.

12. The liquid crystal display device according to claim 9, wherein each V-shaped groove is asymmetrical.

13. The liquid crystal display device according to claim 12, wherein the pluralities of V-shaped grooves are symmetrical related to a central normal of the light incident lateral surface.

14. The liquid crystal display device according to claim 12, wherein the V-shaped groove contains a long slope and a short slope, the light emitting modules are disposed on the opposite positions of the long slopes of the V-shaped grooves respectively.

15. The liquid crystal display device according to claim 12, wherein reflecting layers are disposed on each of the short slopes of the V-shaped grooves.

16. The liquid crystal display device according to claim 9, wherein each of the light emitting modules comprises a circuit board, at least one light emitting diode disposed on the circuit board and a quantum dot glass tube disposed opposite to the circuit board, the circuit board is disposed opposite to the slope of the V-shaped groove, the quantum dot glass tube is disposed between the circuit board and the slope of the V-shaped grooves, and the quantum dot glass tube switches the light shooting from the light emitting diode to white light.
